(19) United States
(12) Patent Application Publication
(10) Pub. No.: US 2016/0076588 A1
(43) Pub. Date: Mar. 17, 2016

(54) IMPACT RESISTANT HIGH SPEED BEARING

(71) Applicant: Schaeffler Technologies AG & Co. KG, Herzogenaurach (DE)

(72) Inventor: William MORATZ, Gardiner, NY (US)

(73) Assignee: Schaeffler Technologies AG & Co. KG, Herzogenaurach (DE)

(21) Appl. No.: 14/807,103

(22) Filed: Jul. 23, 2015

Related U.S. Application Data
(60) Provisional application No. 62/051,492, filed on Sep. 17, 2014.

(51) Int. Cl. F16C 33/32; F16C 32/06; F16C 32/04; F16C 21/00; F16C 33/34

(52) U.S. Cl. CPC F16C 33/32; F16C 21/00; F16C 33/34; F16C 32/0402; F16C 32/0603

(57) ABSTRACT

A bearing arrangement including a first bearing assembly and a shaft supported by the first bearing assembly in a first operating mode is provided. The bearing arrangement includes a second bearing assembly including a second bearing radially inner ring defining a radially inner raceway, a second bearing radially outer ring defining a radially outer raceway, and a second bearing plurality of rolling elements supported to run on the radially inner raceway and the radially outer raceway. The second plurality of rolling elements are formed from a nickel titanium alloy, and a radially inner surface of the second bearing radially inner ring supports the shaft in a second operating mode.

### INCORPORATION BY REFERENCE

The following documents are incorporated herein by reference as if fully set forth: U.S. Provisional Patent Application No. 62/051,492 filed Sep. 17, 2014.

### FIELD OF INVENTION

The present invention generally relates to a bearing arrangement, and more specifically relates to a touchdown bearing.

### BACKGROUND

Bearing arrangements are used in a variety of mechanical applications. Bearing arrangements can include a first bearing assembly that primarily supports a shaft or rotor, and a second bearing assembly that supports the shaft or rotor if the first bearing assembly fails. If the first bearing assembly fails, then the second bearing assembly experiences sudden high impact loading due to high rotational speeds and/or shaft whirl of the shaft or rotor. The sudden high impact loading of the second bearing assembly causes the rolling elements to be forced radially outwardly due to centrifugal forces. This radially outward movement of the rolling elements causes brinelling of the raceways of the second bearing assembly. Brinelling causes the second bearing assembly to malfunction due to excessive vibrations or uneven loading, ultimately causing the entire bearing arrangement to fail. This necessitates replacing the bearing arrangement.

It is known that varying the material of the rolling elements can reduce brinelling. The rolling elements for the second bearing assembly are typically formed from steel. Steel has a relatively higher density than other materials used for rolling elements, which causes large centrifugal forces when the second bearing assembly experiences the sudden high impact loading after the first bearing assembly fails. One alternative material for forming rolling elements includes ceramic material. Ceramic material has a lower density than steel, which helps lower the centrifugal forces caused during the high impact loading of the second bearing assembly. However, ceramic materials have a higher hardness than steel, which results in undesirable brinelling. It would be desirable to provide an alternative material for the rolling elements that is capable of supporting sudden high impact loading without brinelling the races. It would be desirable to form the rolling elements from a material that has a lower density than steel and a lower hardness than ceramic material.

### SUMMARY

A bearing arrangement including a second bearing assembly with rolling elements formed from nickel titanium is provided. The bearing arrangement includes a first bearing assembly and a shaft supported by the first bearing assembly in a first operating mode. The second bearing assembly includes a second bearing radially inner ring defining a radially inner raceway, a second bearing radially outer ring defining a radially outer raceway, and a second bearing plurality of rolling elements supported to run on the radially inner raceway and the radially outer raceway. The second bearing plurality of rolling elements are formed from a nickel titanium alloy. A radially inner surface of the second bearing radially inner ring supports the shaft in a second operating mode. The second operating mode occurs when the first bearing assembly fails. Once the first bearing assembly fails, the second bearing assembly experiences a sudden high impact loading, causing the rolling elements of the second bearing assembly to be thrown radially outwardly due to centrifugal forces. Nickel titanium alloys have a lower density than steel and a lower hardness than ceramic material, which reduces brinelling of the raceways of the second bearing assembly when the first bearing assembly fails.

### BRIEF DESCRIPTION OF THE DRAWINGS

The foregoing Summary and the following detailed description will be better understood when read in conjunction with the appended drawings, which illustrate a preferred embodiment of the invention. In the drawings:

FIG. 1 shows a first embodiment of a bearing arrangement including a magnetic or air bearing as a first bearing assembly.

FIG. 2 shows a second embodiment of a bearing arrangement including a first bearing assembly having rolling elements.

FIG. 3 shows a third embodiment of a bearing arrangement including two touchdown bearings.

### DETAILED DESCRIPTION OF THE PREFERRED EMBODIMENTS

Certain terminology is used in the following description for convenience only and is not limiting. The words “front,” “rear,” “upper” and “lower” designate directions in the drawings to which reference is made. The words “inwardly” and “outwardly” refer to directions toward and away from the parts referenced in the drawings. “Axially” refers to a direction along the axis of a shaft. A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

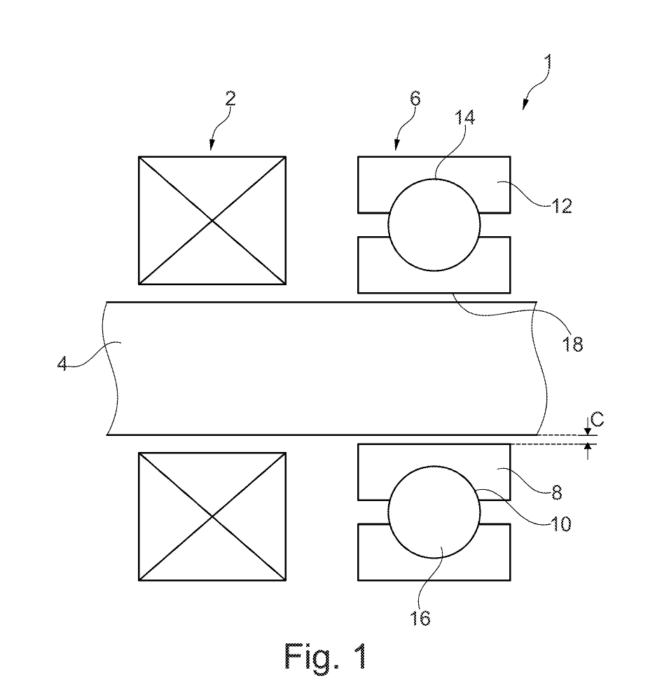

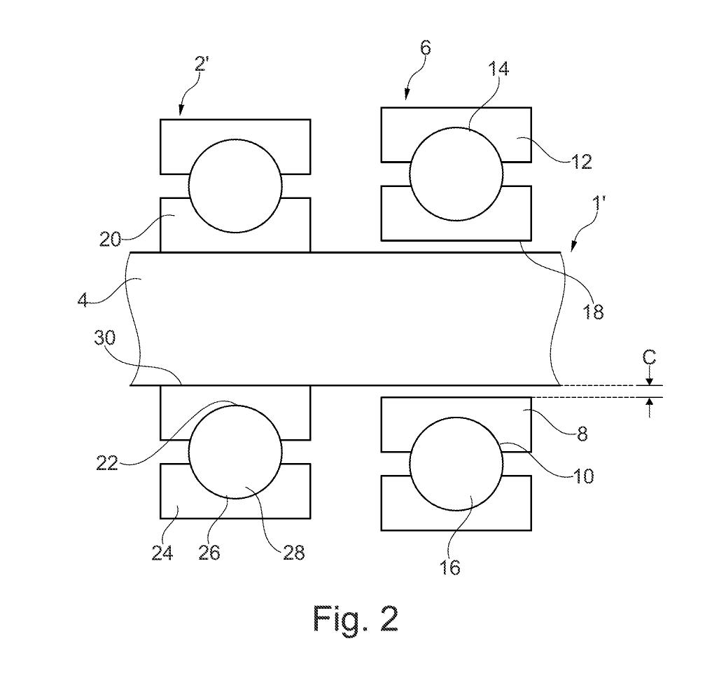

As shown in FIGS. 1 and 2, a bearing arrangement 1, 1′ is provided including a first bearing assembly 2, 2′ and a shaft 4 supported by the first bearing assembly 2, 2′ in a first operating mode. As shown in FIG. 1, the first bearing assembly 2 can be a magnetic or air bearing. As shown in FIG. 2, the first bearing assembly 2′ could alternatively include a first radially inner ring 20 defining a first radially inner raceway 22, a first radially outer ring 24 defining a first radially outer raceway 26, and a first bearing plurality of rolling elements 28 supported to run on the first radially inner raceway 22 and the first radially outer raceway 26. As shown in FIG. 2, the shaft 4 is supported on a radially inner surface 30 of the first radially inner ring 20.

In the embodiments of FIGS. 1 and 2, a second bearing assembly 6 is provided that includes a second bearing radially inner ring 8 defining a radially inner raceway 10, a second bearing radially outer ring 12 defining a radially outer raceway 14, and a second bearing plurality of rolling elements 16 supported to run on the radially inner raceway 10 and the radially outer raceway 14. The second plurality of rolling elements 16 are formed from a nickel titanium alloy. A radially inner surface 18 of the second bearing radially inner ring 8 supports the shaft 4 in a second operating mode in which the first bearing assembly 2, 2′ fails. The second bearing assembly 6 can also be referred to as a touchdown bearing. The second bearing assembly 6 is provided as a back-up bearing in the event of first bearing assembly 2, 2′ failure in order to protect equipment from damage, etc.

In one preferred embodiment, the second plurality of rolling elements 16 are formed from NiTiNOL 60. In another embodiment, the second plurality of rolling elements 16 are formed from NiTiNOL 55. A nickel titanium alloy rolling element has a lower density than steel, and a lower hardness and is less brittle than ceramic materials. Nickel titanium alloys exhibit better damping characteristics than ceramic materials. This results in the bearing being less susceptible to brinelling damage in the second operating mode. In one embodiment, the second bearing radially inner ring 8 and the second bearing radially outer ring 12 are formed from steel. As shown in FIGS. 1 and 2, a clearance C is provided between the radially inner surface 18 of the second bearing radially inner ring 8 and an outer diameter of the shaft 4.

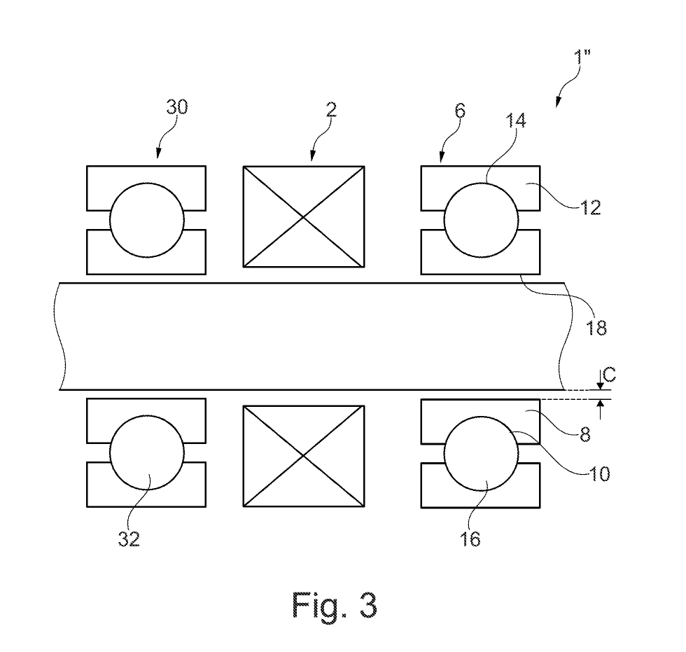

As shown in FIG. 3, a third bearing assembly 30 is provided in an embodiment of a bearing arrangement 1″. The bearing arrangement 1″ of FIG. 3 is similar to FIG. 1, except a second bearing assembly 6 and third bearing assembly 30 are provided on either axial side of a first bearing assembly 2. The third bearing assembly 30 includes a plurality of nickel titanium alloy rolling elements 32, similar to the second plurality of rolling elements 16 described above. The components of the third bearing assembly 30 are similar to the components described above with respect to the second bearing assembly 6.

Having thus described the presently preferred embodiments in detail, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiment and optional configurations are therefore to be considered in all respects as exemplary and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

What is claimed is:

1. A bearing arrangement comprising:
a first bearing assembly;
a shaft supported by the first bearing assembly in a first operating mode; and
a second bearing assembly including a second bearing radially inner ring defining a radially inner raceway, a second bearing radially outer ring defining a radially outer raceway, and a second bearing plurality of rolling elements supported to run on the radially inner raceway and the radially outer raceway, the second plurality of rolling elements are formed from a nickel titanium alloy, and a radially inner surface of the second bearing radially inner ring supports the shaft in a second operating mode.

2. The bearing arrangement of claim 1, wherein the second operating mode is a failure mode of the first bearing assembly.

3. The bearing arrangement of claim 1, wherein the first bearing assembly includes a first radially inner ring defining a first radially inner raceway, a first radially outer ring defining a first radially outer raceway, and a first bearing plurality of rolling elements supported to run on the first radially inner raceway and the first radially outer raceway, and the shaft is supported on a radially inner surface of the first radially inner ring in the first operating mode.

4. The bearing arrangement of claim 1, wherein the first bearing assembly is a magnetic bearing.

5. The bearing arrangement of claim 1, wherein the first bearing assembly is an air bearing.

6. The bearing arrangement of claim 1, wherein the second bearing plurality of rolling elements are formed from NiTiNOL 60.

7. The bearing arrangement of claim 1, wherein the second bearing radially inner ring and the second bearing radially outer ring are formed from steel.

8. The bearing arrangement of claim 1, wherein a clearance is provided between the radially inner surface of the second bearing radially inner ring and an outside of the shaft.
